(19) United States
(12) Patent Application Publication
(10) Pub. No.: US 2004/0197161 A1
(43) Pub. Date: Oct. 7, 2004

(54) Metric/standard magnetic motor oil plug

(76) Inventor: Luis A. Gonzalez, Riverside, CA (US)

Correspondence Address: Mr. Luis A. Gonzalez, 4297 Pondhill Ct, Riverside, CA, 92505, US

(21) Appl. No.: 10/407,035

(22) Filed: Apr. 4, 2003

(51) Int. Cl. F16B 35/02

(52) U.S. Cl. 411/383

(57) ABSTRACT

The Metric/Standard magnetic motor oil plug is designed to provide optimum holding power. This part, including the rubber band, is completely magnetic.

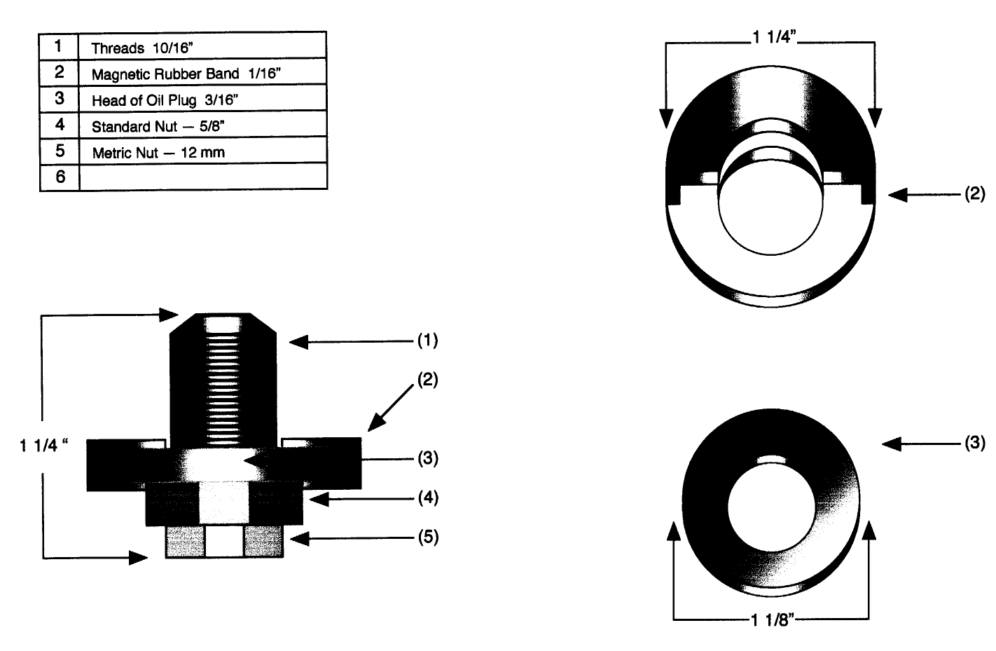

### BACKGROUND OF THE INVENTION

My car was leaking motor oil. It was the second time that we had changed the oil plug. The second oil plug was metric. The mechanic damaged the oil plug because he used a non-metric tool. The regular oil plug had two problems: first, the circumference was small; not big enough to stop the leaking of the oil. Second, a rubber band attached is not good enough to stop the leaking. The intention of the invention is to improve the current oil plugs in the market.

### SUMMARY OF THE INVENTION

The Metric/Standard Magnetic Motor Oil Plug will have the following benefits:

1. The whole part is magnetic; therefore, it will provide optimum holding power.

2. The part will have a section to use metric or standard tools for opening and closing the oil plug.

3. The circumference of the head of the oil plug will be bigger for better security.

4. A magnetic rubber band will add major effectiveness.

### BRIEF DESCRIPTION OF THE VIEWS OF THE DRAWING

The motor oil plug is completely magnetic to provide maximum holding power to the engine. The part consists of the threads head of oil plug (10/16″), the magnetic rubber band (1/16″) that will be around the head of Oil Plug (3/16″), the standard nut (⅝″), and the metric nut (12 mm).

### DETAILED DESCRIPTION OF THE INVENTION

The Metric/Standard Magnetic Motor Oil Plug is an improvement to the current motor oil plug. The difference consists in the materials used and the measurements. This new part will be totally magnetic to provide maximum holding to the engine. It will also have metric and standard nuts, making it possible to use either one tools. The circumference of the head of the oil plug (1 ⅛″), will become 1 ¼″ with the added magnetic rubber band. The part consists of the threads head of oil plug (10/16″), the magnetic rubber band (1/16″) that will be around the head of Oil Plug (3/16″), the standard nut (⅝″), and the metric nut (12 mm).

1. What I claim as my invention is the Metric/Standard Magnetic Motor Oil Plug. This motor oil plug consists of the threads head of oil plug (10/16″), the magnetic rubber band (1/16″) that will be around the head of Oil Plug (3/16″), the standard nut (⅝″), and the metric nut (12 mm).
